(19) United States
(12) Patent Application Publication
(10) Pub. No.: US 2009/0158155 A1
(43) Pub. Date: Jun. 18, 2009

(54) PLAYLIST GENERATION, DELIVERY AND NAVIGATION

(75) Inventors: Paul Quinn, Kensington, CA (US); Robert Milton Parker, IV, Suwanee, GA (US); Michael W. Mantle, San Rafael, CA (US); Maxwell Wells, Seattle, WA (US); Scott A. Jones, Carmel, IN (US); Richard Williams, Pleasant Hill, CA (US)

Correspondence Address: SCHWEGMAN, LUNDBERG & WOESSNER, P.A., P.O. BOX 2938, MINNEAPOLIS, MN, 55402, US

(73) Assignee: Gracenote, Inc., Emeryville, CA (US)

(21) Appl. No.: 12/266,124

(22) Filed: Nov. 6, 2008

Related U.S. Application Data
(62) Division of application No. 10/228,261, filed on Aug. 27, 2002.
(60) Provisional application No. 60/314,664, filed on Aug. 27, 2001.

(51) Int. Cl. G06F 3/048; G06F 17/40; G06F 7/06; G06F 17/30

(52) U.S. Cl. 715/716; 707/104.1; 707/3; 707/102; 707/103 Z; 707/E17.143; 707/E17.045; 707/E17.002; 707/E17.018; 707/E17.009

(57) ABSTRACT

Automatic and assisted playlist generation is accomplished by collecting data from users of a world-wide music information system. Attributes of the recordings listened to by users are extracted from data collected when the users access the music information system. The attributes are correlated with other attributes in the system to verify data accuracy. Users can specify a set of attributes of their music collection for automatic generation of a playlist. The playlist can then be further edited, even on devices with a limited display and a few buttons designed for playback of recordings, by re-mapping the functions of the buttons for playlist generation.

### CROSS-REFERENCE TO RELATED APPLICATIONS

This application is a divisional of U.S. application Ser. No. 10/228,261 filed Aug. 27, 2002, which is related and claims priority to the U.S. provisional application entitled, PLAYLIST AND MUSIC MANAGEMENT FOR DEVICES, having Ser. No. 60/314,664, filed Aug. 27, 2001, which applications are incorporated in their entirety herein by reference.

### BACKGROUND OF THE INVENTION

1. Field of the Invention

The present invention is directed to playlist and music management using a computer network and, more particularly, to providing tailored listening experiences based on aggregate music listening behavior data collected using network protocols for music information services.

2. Description of the Related Art

Over the past few years, there has been an explosion in the number of computer applications, consumer electronics devices in homes and cars, and portable devices, that play music. These computer applications and devices have increased the need to manage media collections. One form of media management uses playlists to select and determine recordings and order of playback.

A playlist is a collection of recordings of songs or tracks on an album, such as a compact disc (CD), or audio files on permanent or removable storage media accessed by a computer or other device capable of playing back music. The playlist may be associated with a single CD to select or reorder the tracks for playback, or may be associated with multiple CDs if the device is capable of accessing more than one CD automatically, or audio files on some other storage medium. A playlist may consist of music with one or more attributes having sufficient similarity to provide a coherent theme or mood. Examples of playlists include music by a specific performing artist, such as the Beatles, rock music form the '70s, acoustic guitar solos, popular works of Johann Sebastian Bach, music to relax by, music played by teenage girls and music played by listeners with compatible tastes.

Playlists are used to minimize the effort required to manage recordings stored on media accessible by personal computers or consumer electronics devices. In addition, playlists can be used by listeners to learn about older recordings that they do not have, but are likely to enjoy and recently created music that they may find they like. Thus, it is possible to create a playlist of music that is on recordings possessed by a user combined with music that they have a high probability of liking.

Conventionally, playlists are created manually, automatically, or by a combination of automatic and manual steps. Manual playlists are created by professionals or listeners. An album, such as a CD, contains the combination of musical recordings with a playlist created by the recording artist or the company publishing the CD. Disc jockeys (DJs) also create and sometimes publish playlists. The human involvement in creating a playlist manually results in a playlist that at least one person enjoys, however, it is time consuming for individuals to create their own playlists. Playlists created by professionals are typically aimed at a mass market that individuals may find unsatisfactory.

Methods have been used to generate playlists automatically using algorithms which use weighted combinations of attributes, such as the attributes described below. One of the advantages of automatically generated playlists is that large quantities of music can be processed with little individual effort. However, known algorithms are limited by the quality of the attributes and defining and assigning values to the attributes is very time consuming. Known methods for extracting attributes are not sophisticated enough to result in good playlists. Collaborative filtering techniques typically do not work well with music created recently.

One way to overcome the drawbacks of automatically generated playlists is to “edit” such playlists manually. This combines the efficiency of automatically generated playlists with the benefits of human selection. However, known techniques for automatically generating playlists result in playlists of such low quality that excessive manual intervention is required. This is particularly unsatisfactory when the editing is performed on consumer electronics devices which typically have a user interface that is awkward to use.

Attributes used in automatic playlist generation can be broken down into four types: Intrinsic Objective Attributes (IOAs)—Information which can be derived directly from the music. without recourse to subjective interpretations as to the meaning of the music, its semantic content, or the intent of the composer or performer. Examples include the beat texture (or tempo) and language of the lyrics. Intrinsic Subjective Attributes (ISAs)—Information which is contained within the recorded music, but which is generally only extractable after it has been run through the filter of human understanding. Examples include genre and artist compatibility or incompatibility.

Extrinsic Objective Attributes (EOAs)—Information which is not contained within the recorded music and which does not require interpretation by humans. Examples include the name of the artist, the track and album titles, or the locale where a track is most popular.

Extrinsic Subjective Attributes (ESAs)—Information that is not contained within the recorded music. Generally ESAs are data about the human responses to, and uses of, the music. ESAs also extend to data about the lifestyles of the purchasers and performers of the music. Examples of ESAs include critical reviews, and the psychographics of the purchasers of the music.

One way to create better playlists of all types is to develop better attributes. With improved attributes, professionals and individuals can more easily create individualized playlists and algorithms should be able to develop playlists of higher quality. As a result, playlists generated using a hybrid of automatic and manual techniques will have higher quality with less work. In addition, improved algorithms and better methods for interfacing with playlists will result in better playlists.

### SUMMARY OF THE INVENTION

An aspect of the present invention is to create attributes for playlist generation by automatically collecting data from a large number of listeners. Another aspect of the present invention is to provide methods of operating on automatically created attributes to make them useful for playlist generation.

A further aspect of the present invention is to provide algorithms for automatic playlist generation that produce playlists that listeners like to use.

Yet another aspect of the invention is to deliver playlists to individual devices.

A still further aspect of the invention is to provide user interfaces for locally managing playlists and recordings.

Yet another aspect of the invention is to integrate data collection, attribute creation and playlist generation with existing computer systems and devices while retaining flexibility to adapt to continually evolving standards for on-line services.

A still further aspect of the invention is to automatically determine the popularity of artists, tracks and albums, the locale and language of listeners and artists and compatibility between genres, artists and tracks.

Yet another aspect of the invention is to automatically detect errors of omission and commission in the collection of data for attribute creation and playlist generation.

A still further aspect of the invention is to aggregate data so that individual contributors are anonymous.

Yet another aspect of the invention is to search for compatibility between users.

A still further aspect of the invention is to detect leading indicators of the popularity of songs.

The above aspects can be attained by a method for creating playlists, including aggregating data collected from users related to recordings possessed by the users; creating attributes for the recordings; and generating playlists based on the attributes and user input.

These together with other aspects and advantages which will be subsequently apparent, reside in the details of construction and operation as more fully hereinafter described and claimed, reference being had to the accompanying drawings forming a part hereof, wherein like reference numerals refer to like parts throughout.

### BRIEF DESCRIPTION OF THE DRAWINGS

FIG. 1A is a functional block diagram of data collection, attribute creation and playlist generation according to the present invention.

FIG. 1B is a flowchart of a data cleansing process according to the present invention.

FIG. 2 is a block diagram of fingerprint error correction using audio fingerprints extracted from recordings.

FIG. 3 is flowchart of a method for determining the language of an artist and a submitter.

FIG. 4 is a flowchart of a method for determining the compatibility of a new genre with existing genres using a database of user submissions.

FIG. 5A is a block diagram of a system for logging music recognition queries.

FIG. 5B is a block diagram of a system for periodically anonymizing query logs.

FIG. 6 is a functional block diagram of a method for identifying groups of compatible users, which will be termed “music tribes.”

FIG. 7 is a functional block diagram of a method for identifying trendsetters.

FIG. 8A-8C is a block diagram of a system for delivering data to devices.

FIG. 9 is a state flow diagram for a user interface according to the present invention.

### DETAILED DESCRIPTION OF THE PREFERRED EMBODIMENTS

Improved playlist generation according to the present invention begins with world-wide data collection to produce playlists based on aggregate music listening behavior of millions of users annually. The system described below is used to collect the four types of attributes that are either intrinsic or extrinsic and are either objective or subjective.

Basic music metadata is occasionally provided on a Compact Audio Disc as CD Text that identifies the name of the CD album, the artist's name, the name of each song on the CD, in addition to the genre of the songs. When digital audio files are generated by computer applications that “rip” the audio and convert it to a digital audio file, this information may be written into the metadata tags of the digital audio file and/or imported as part of the file name of the digital audio file. If this basic music metadata is not provided as CD Text on the CD, an Internet-based music information service such as CDDB is often used to identify, and then provide basic metadata about the CD.

For many music-playing applications, each time a user plays a CD or digital audio file, a connection is made to the music information server via a dial-up or persistent Internet connection. The server identifies the CD or digital audio file being played and returns basic metadata about the music to the user. Concurrently, the album or digital audio file identified by the request and other relevant information about the query is logged for analysis at a later. This logged information can be processed to create intrinsic and extrinsic attributes, and used to complement the basic metadata associated with digital audio files.

One example of a world-wide music information system is the CDDB system available from Gracenote, Inc. of Berkeley, Calif. In the CDDB system, if a user attempts to play a CD or digital audio file that the system does not recognize, the system returns no basic metadata and requests the user to supply basic metadata for subsequent identification. The basic metadata requested includes artist name, album name, song name(s), release data, plus primary and secondary genre of the music. Such information entered by the user, is then returned via the Internet to the music information service where it is processed and algorithmically reviewed.

Collecting all this data is only the first part of the process. All the data must then be stored and made available for access by applications or devices that desire to create playlists and manage music collections. In an embodiment of the invention, an Internet-based music information service provides these intrinsic and extrinsic attributes in addition to the basic metadata when CDs or songs are identified.

Information used for creating attributes or generating playlists can be obtained from existing databases, data entered by users or data automatically generated on user (client) devices (personal computers or consumer electronics devices) that are connected or connectable to a computer network, such as the Internet. It is advantageous to generate attributes on client devices, because information may not be available on servers connected to the network for some of the recordings played on the client and users may wish to develop weightings or algorithms to create attributes used in the creation of custom playlists. Therefore, in one embodiment of the present invention attributes are created on client devices and may be combined with attributes obtained from or derived from information stored on servers, to generate playlists.

In addition to the techniques described below for creating attributes, any attributes of songs in existing databases or known techniques for generating attributes may be used to produce attributes for playlist generation according to the present invention. For example, the music searching methods based on human perception disclosed in PCT published patent application WO 01/20609 and the related U.S. patent application Ser. Nos. 09/556,086 and 60/153,768, all three incorporated herein by reference, may be used to extract intrinsic objective attributes. It is also advantageous to use any known technique for obtaining tactus information about a song where tactus is the human perception of the speed of a song.

There are existing systems which collect data about music listeners who use personal computers to play compact discs and audio files. In the near future, it is expected that more consumer electronics devices will also be able to be connected to the Internet or another computer network via which data can be collected about listener behavior. In addition, many methods for collecting data of listening habits have been disclosed or suggested, such as the method disclosed in U.S. Pat. No. 6,330,593, incorporated herein by reference. These methods can be used to determine world-wide music listening behavior of millions of users annually based on a vast amount of data that captures the listening habits for a wide range of music. However, some of the known techniques rely on user-submitted data which typically contains errors of omission and commission, both of which need to be corrected to improve its utility.

According to one embodiment of the present invention, data which may contain errors, such as user-submitted data, are processed by a set of heuristics that attempt to bring disparate (but equivalent) queries together to form a common query statistic. These heuristics have the objectives of identifying the datum, i.e. determining the correct spelling for a particular recording (e.g., “Beatles” or “Beetles”) and identifying different spelling variants as corresponding to the same datum, such as identifying “Beattles” as “Beatles” and even “Fab Four” as “Beatles.”

According to an embodiment of the invention, requests for information about recordings, whether a compact disc or a digital music file, from client devices to a music information service are judged for similarity using a form of fuzzy matching, where requests that are “similar enough” are counted together to form a combined statistic. Requests which are found to be similar, but not similar enough to be automatically combined often are returned to the user who is requested to identify the correct item. Where the user returns an identification of the correct item to the music information service, the similar item is marked as “potentially similar.” After a sufficient number of users have identified the same result, the item is included in the “similar” set of fuzzy matches and identified as an “inferred” match.

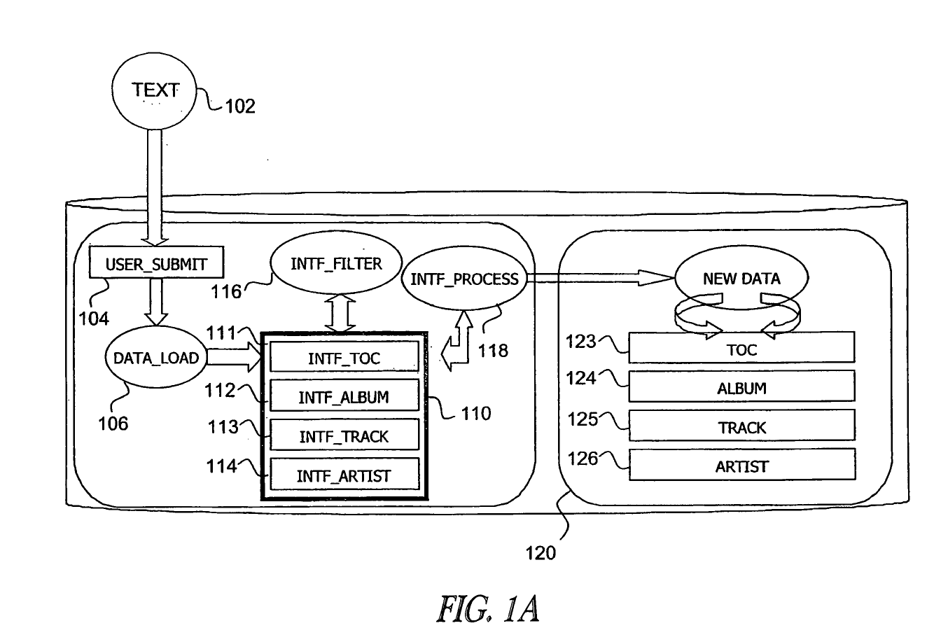

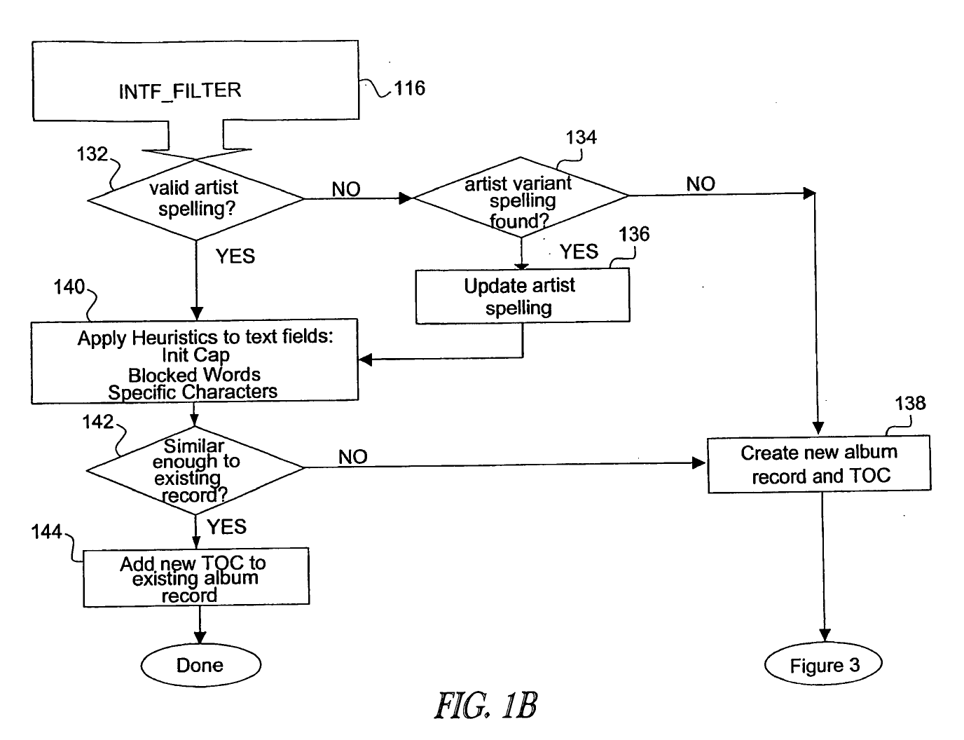

A system is illustrated in FIG. 1A for processing user submitted data using the method illustrated in FIG. 1B. Text 102 forms a USER_SUBMIT record 104 that is received by a DATA_LOAD process 106 and stored in interface database 110 containing interface tables 111-114 and interface filter (INTF_FILTER) 116 to clean, validate and translate normalized data in tables 111-114. An interface process (INTF_PROCESS) 118 matches and merges text 102 with master metadata database 120 containing the following data for compact discs: table of contents (TOC) 123, album title 124, track title 125 and artist name 126.

As illustrated in FIGS. 1A and 1B, interface filter process 116 determines 132 whether the artist information supplied by a user has a valid spelling by comparing the artist name with an existing database of artists. If there is no match and it is determined 134 that an artist variant spelling can be found, the spelling supplied by the user is updated 136. If no artist variant spelling is found, it is (at least temporarily) assumed that the user is submitting information about a recording that is not in master metadata database 120 and a new record is created 138. The new record is stored with information input by the user and data based on information extracted from the recording or associated therewith, such as the TOC of a compact disc. If a valid artist spelling is obtained from the user by identifying 134 a variant spelling, heuristics are applied 140. For example, if the text 102 submitted by the user is identified as English, standard rules are applied to capitalize initial letters of most of the words in the title, or if known invalid words or character strings are identified (e.g., “Track 01”, “QWERTY”, “QWE”, “RTY”) those words or text strings are blocked from the submission. If the text 102 is in another language, appropriate capitalization or other rules may be applied.

Next, it is determined 142 whether the TOe, Artist Name, Album Name, Track Names, and other EOAs and ESAs are similar enough to a sufficient number of entries that the entry can be accepted. Whether there are “a sufficient number” depends on the popularity of the recording. If there is a sufficient number with similarity to an existing record in master metadata database 120, the TOC is added 144. If not, a new record is created 138.

An embodiment of the present invention uses intrinsic objective attributes to correct errors in extrinsic objective attributes stored in master metadata database 120. The intrinsic objective attributes may be based on table of contents (TOC) information, such as track duration, or the digital content of the music as abstracted into a secure hash algorithm, or a fingerprint extracted from the recording, e.g., as disclosed in U.S. patent application Ser. No. 10/200,034, filed Jul. 22, 2002 and incorporated by reference herein.

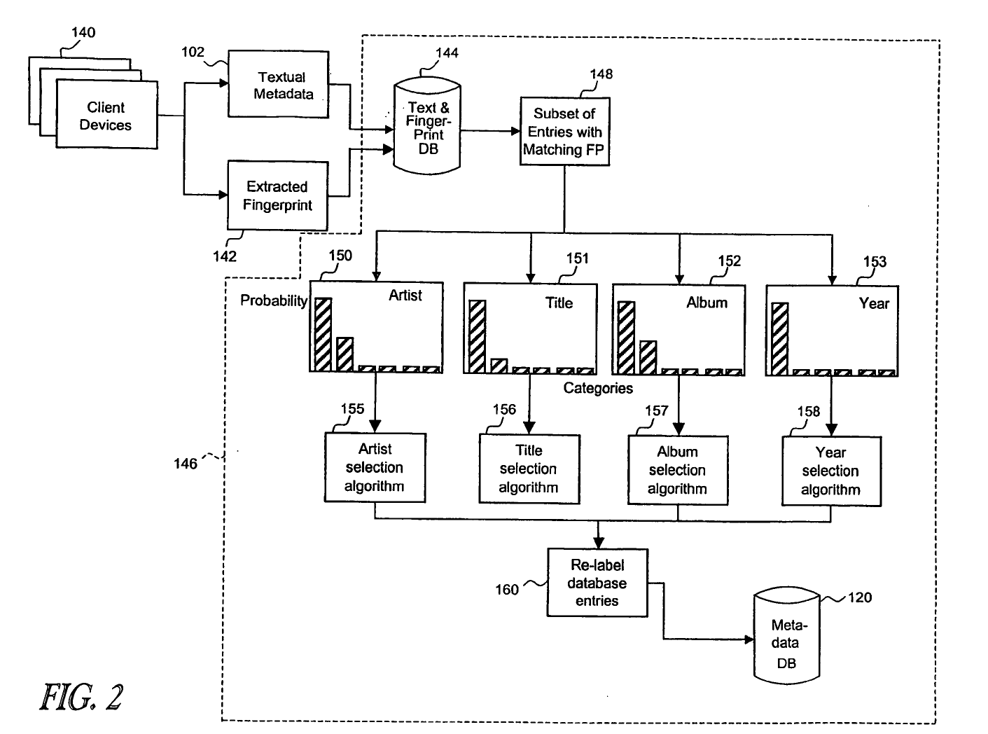

As illustrated in FIG. 2, client devices 140 (personal computers or consumer electronics devices) submit textual metadata 102 and to extract fingerprints 142 for storage in text and fingerprint database 144 in at least one server 146. Textual metadata 102 may include artist name, album title and track title as in the case of interface database 110 in FIG. 1A. In addition, the textual data may include the year the track was recorded or the album was released, or other date information. When several records having matching fingerprints have been stored in text and fingerprint database 144, a subset 148 of entries with matching fingerprints is created that may contain correctly spelled artist name and titles (e.g., “The Beatles”), incorrectly spelled artist name and titles (e.g., “The Beetles”), incorrect artist name or titles (e.g., “The Who” instead of “The Beatles”) and other random errors.

According to the present invention, variations in spelling and dates are categorized with one spelling per category, normalized to create a probability density function and ranked from most probable to least probable for each piece of information as represented by bar graphs 150-153. Selection algorithms 155-158 are used to select a most likely correct artist name, track title, album title, year, etc. based on the size of the probability of the most frequently occurring data item, e.g., artist spelling, total number of occurrences of that data item or spelling and the size of the probability of alternatives to that data item, such as different artist spellings. Different weightings of the variables may be used in each of the algorithms 155-158 to account for differences in the quantity and quality of the errors of each data type. The selected data items are used to update 160 or re-label entries in master metadata database 120. Note that while master metadata database 120 and text and fingerprint database 144 are illustrated in FIG. 2 as separate databases, a single database may be used for both, with appropriate flags indicating the stage of processing of the data (confidence in accuracy of the data).

After a data record has been subjected to extensive validation, possibly including human editing, a record may be determined to be correct and therefore is “locked down.” For such records, when a mismatch occurs between user submitted data 102 and a record in master metadata database 120 having a matching fingerprint, the entry for the sound recording from that user is assigned the metadata from the “locked down” record.

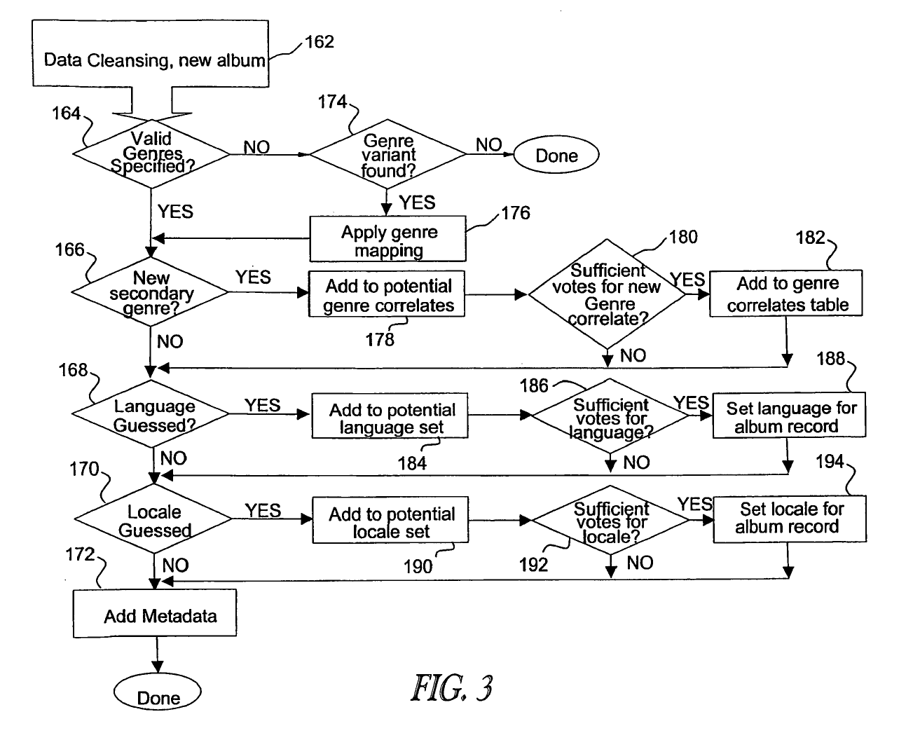

Text 102 provided by users and other sources of information can be processed to obtain additional objective, subjective, intrinsic and extrinsic attributes. An example of such processing is illustrated in FIG. 3 for information about an album not currently stored in master metadata database 120, such as information relating to genre (ISA), language used in the submitted text, which can be used to infer the language of the lyrics (IOA), location of the user (EOA), etc. The location or locale of the user may be derived from a network address or other information in the communication network connecting client devices 140 and server(s) 146 to aid in determining the language used. In addition, when almost all submissions or other user accesses to master metadata database 120 are from geographically close locales, a generic locale may be assigned to the artist as another extrinsic objective attribute.

Genres are labels used to describe a style of music. While the names of genres originate from listeners or creators of the music, over time they become established with generally accepted meanings and subgenres. An example is “Classical” with subgenres of Baroque, Romantic, Opera, etc. and sub-subgenres, such as Italian Opera. Several other examples of genres are listed in the genre mapping table farther below.

Many genres are not applied as consistently as classical music and even classical music is not always consistently applied, particularly to newly composed symphonic pieces. Furthermore, genres are continually being created and most individuals only know a few genres. In addition, there are several different organizations that produce lists of genres, and some use different terms to refer to the same genre or categorize music in different ways, so that a genre from one organization may overlap a genre from another. In addition, genres change over time. For example music that was considered “country” 40 years ago sounds different from much of “country” music today. Also, genres may be applied with different levels of granularity to an artist, album or track, and individual artists, albums or tracks may fit within more than one genre.

According to the present invention, the problems associated with genres discussed in the preceding paragraph are addressed by using voting methods to determine the most popular and consistent genre for a track, artist or album. Preferably, genres are presented to users hierarchically or in groups, or some other manner that is easily understood, so that the appropriate genre is included in text 102 submitted by users and so that new genres can be understood in the context of existing genres. This is analogous to lesser known color names, such as “bisque” and “gainsboro” being described as the more commonly known “tan”, and “gray.”

In the preferred embodiment, the most appropriate genre for a track, artist or album is based on master metadata database 120 of user submissions 102. For tracks stored in master metadata database 120, a voting method is used in which the most popular genre, above some threshold, is determined to be most appropriate. In a preferred embodiment, the threshold may be automatically varied based on the popularity of the track, i.e., the number of user submissions received for a track. In other words, the primary genre is the consensus of all those who submit a genre for the item based upon voting criteria that may be preestablished or developed through heuristics.

Although techniques are preferably used to help users understand how genres are defined, genres are likely to be indicated differently by different users. As noted above, the appropriateness of an assignment of a genre to an artist, album or recording is ultimately determined by listeners. Therefore, according to the present invention, voting is used to determine the genre(s) assigned to an artist, album or recording.

As illustrated in FIG. 3, text 162 for an album that is not established in master metadata database 120 may be processed by interface process 118 (FIG. 1A) or at a later time using records stored in master metadata database 120 having an indication that the data has not been “locked down”. If a valid genre is specified 164, it is determined 166 whether a new secondary genre is included in text 162. If not, text 162 is checked 168 for possible language identification, e.g., based on the character set used, such as Japanese or Korean characters. If not, there is an attempt to guess 170 the locale of the user using a reverse IP mapping technique and if unsuccessful, the metadata 102, 142, TOC, and other information associated with the recording or album are added 172 to master metadata database 120.

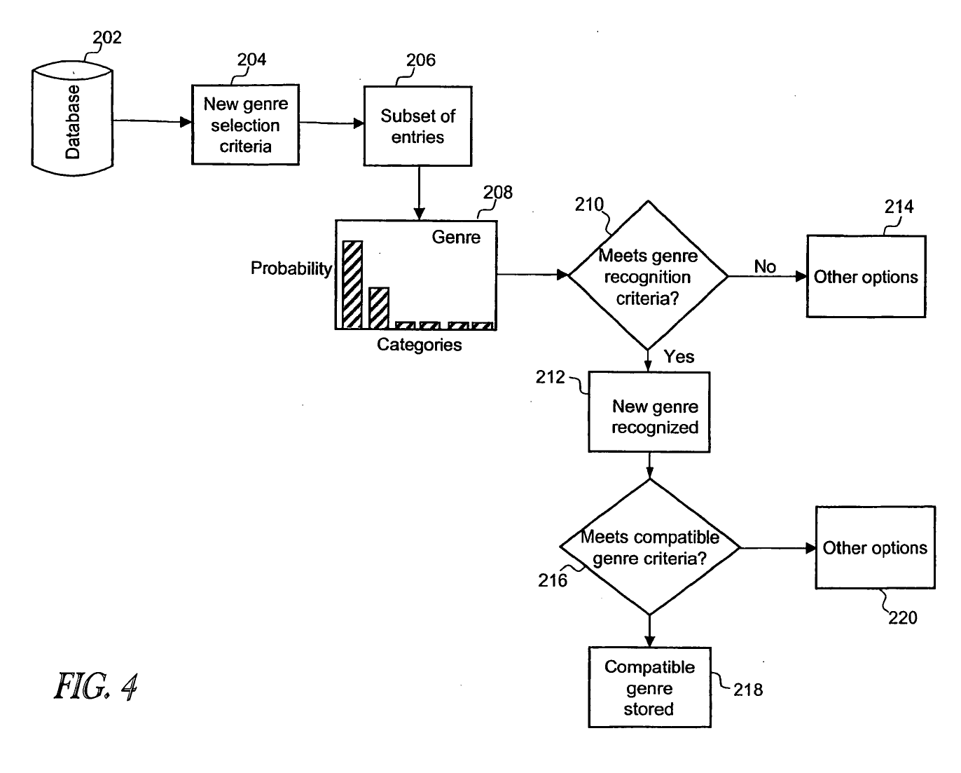

If no valid genres are specified 164, it is determined 174 whether a genre variant is found and if not, the information is stored for later processing. Details on making this determination are described below with respect to FIG. 4. If a genre variant is found, genre mapping is applied 176 as described below to use the genre text in master metadata database 120. If a new secondary genre is identified 166, the secondary genre is added 178 to potential genre correlates when sufficient votes for a new genre correlate have been received 180. While the secondary genre is based on a consensus, like the primary genre, the secondary genre is also added 182 to a set of genre correlates that is maintained for each genre within the system. The genre correlates collected by consensus of all users who submit genres for all albums and recordings, preferably has a weighting assigned to each genre correlate that provides a degree of closeness to the original genre. The genre correlate data set can then be used for playlist management and generation as described below.

When the language of text 162 is possibly identified 168, the language is added 184 to a potential language set and when sufficient votes are received 186, the language is added 188 to the record in master metadata database 120. When it is possible to guess 170 the locale, the locale is added 190 to a potential locale set and when sufficient votes for that locale are received 192, the locale is stored 194 in the corresponding record in master metadata database 120.

When text 162 is submitted by users for recordings that are not identified as associated with an existing genre, new genres may be identified using manual, machine-listening and data-mining techniques. As an example of manual techniques, when the database detects a number of examples of a new genre exceeds some predetermined threshold based on accesses to the database, number of listeners and recordings, an expert could acquire and listen to recordings of the new genre, confirm that it is a new genre and find the most compatible genres for each track, artist and album, e.g., to establish genre correlates. As an alternative to listening by human expert, machine-listening could be used, e.g., using the process disclosed in WO 01/20609 the Assignment of genres to track album and artist is performed automatically in this case.

An example of a data mining technique that can be used to identify a new genre and identify its compatible genres is illustrated in FIG. 4. Master metadata database 120 containing world-wide information is mined for information on an ongoing basis. Criteria are determined 204 about when a new genre is suspected to have arisen. These criteria may include thresholds for occurrences of examples of the new genre being submitted to the database, the number and geographic locale of listens and listeners of the new genre, the number of sound recordings designated as the new genre, etc. Using these criteria, a subset 206 of entries is created consisting of all tracks with the same artist and title, all tracks with the new genre and all other tracks by the same artist. The genres in this subset consist of (1) the new genre, (2) other genres which have been assigned to the track and which are probably related to the new genre, (3) genres from previous tracks by the same artist, each of which have a high probability of being related to the new genre, and (4) other random errors.

The genres in subset 206 are placed into categories, one genre per category and normalized to create a probability density function prior to ranking 208 from most to least likely. Genre recognition criteria are applied 210, such as whether the new genre is the highest probability category the size of that probability, and the size of the probability of other genres (categories). If the new genre does not meet the criteria 210 to be recognized as a new genre 212, other options 214 may be applied, such as machine listening or manual determination as described above. Next, compatible genre recognition criteria are applied 216, such as whether the second-most probably category exceeds some probability, both absolutely and relative to the most popular genre. If recognized, the compatible genre is stored 218 and otherwise other options 220 may be pursued.

As noted above, many different organizations have listed genres. Users of the service are likely to be familiar with one or more of these genre lists and identify the genre of a track, album or artist based on a classification different than that used by master metadata database 120. This applies equally well to subgenres or finer classifications within each genre. In the preferred embodiment, genre re-mapping is performed through a genre correlation function that utilizes an exhaustive set of genre relationships mapped to basic genres. This allows the genre correlations developed for all genres to be utilized for files that are not tagged with appropriate genre data. This includes mapping all genres from text associated with compact discs, mp3 ID3 v2, etc. to the appropriate genre used in master metadata database 120 so that the genre correlates will work effectively for all files. An example of a map from mp3 ID3 v2 tags to the genres used in master metadata database 120 is provided in the following table. Other sources of genre lists include the Muze and AMG databases, Microsoft Windows Media Player, mp3.com, artist Direct, Amazon, Yahoo!, Audio Galaxy, ODP and RIAJ.

| | | |
|---|---|---|
| ID3 Genre | CDDB2 Genre ID | CDDB2 Genre Name |

| | | | |
|---|---|---|---|
| 0. | Blues | 31 | General Blues |
| 1. | Classic Rock | 185 | Classic Rock |
| 2. | Country | 60 | General Country |
| 3. | Dance | 67 | Club Dance |
| 4. | Disco | 173 | Disco |
| 5. | Funk | 188 | Funk |
| 6. | Grunge | 11 | Grunge |
| 7. | Hip-Hop | 136 | General Hip Hop |
| 8. | Jazz | 160 | General Jazz |
| 9. | Metal | 189 | General Metal |
| 10. | New Age | 169 | General New Age |
| 11. | Oldies | 69 | Pop Vocals |
| 12. | Other | 221 | General Unclassifiable |
| 13. | Pop | 175 | General Pop |
| 14. | R&B | 34 | General R&B |
| 15. | Rap | 137 | General Rap |
| 16. | Reggae | 246 | General Reggae |
| 17. | Rock | 191 | General Rock |
| 18. | Techno | 117 | General Techno |
| 19. | Industrial | 111 | General Industrial |
| 20. | Alternative | 10 | General Alternative |
| 21. | Ska | 208 | 3rd Wave/Ska Revival |
| 22. | Death Metal | 186 | Black/Death Metal |
| 23. | Pranks | 20 | Comedy |
| 24. | Soundtrack | 216 | Film Soundtracks |
| 25. | Euro-Techno | 103 | Deep House |

The resulting genre relationship table may be used to help classify songs stored on a personal computer or consumer electronic device, according to the genre(s) selected for creating a playlist. Additionally, genre grouping categories can be provided to help user more simply manage their music selections. For example, grouping can contain 50's, 60's, 70's, “Smooth Jazz”, etc.

The following table is an example of the most popular albums/songs in a worldwide music information database which makes the genre correlation capabilities extremely effective since it shows that for the most popular albums the genres are from a variety of genres, not just General Rock. Genre aggregation builds upon the granularity exhibited in the following table by mapping all of the most popular genres used in tagging mp3 files into the genres and genre-groupings used in master metadata database 120.

| Genre | Albums |
|---|---|
| General Rock | 7.01% |
| Hard Rock | 3.80% |
| Classic Rock | 3.28% |
| General Soundtrack | 2.74% |
| General Pop | 2.73% |
| Folk-Rock | 2.52% |
| Film Soundtrack | 2.30% |
| Soft Rock | 2.04% |
| General Unclassifiable | 1.90% |
| General Alternative | 1.85% |
| Japanese Pop | 1.76% |
| New Wave | 1.72% |
| Soul | 1.59% |
| European Pop | 1.56% |
| General R&B | 1.48% |
| General Country | 1.48% |
| Contemporary Country | 1.44% |
| Indie | 1.42% |
| Heavy Metal | 1.38% |

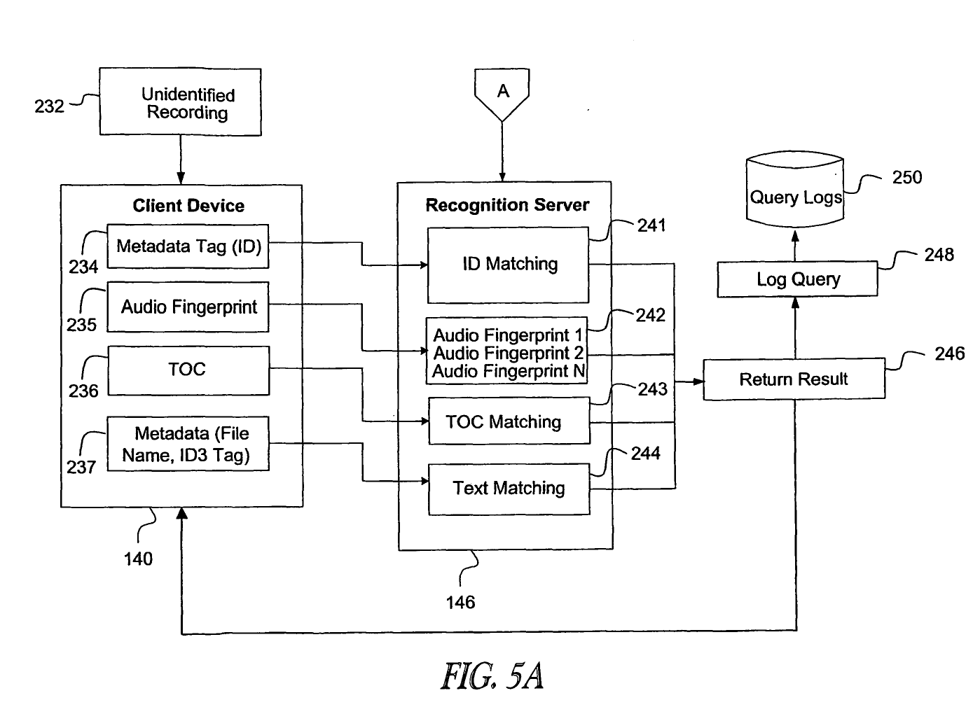

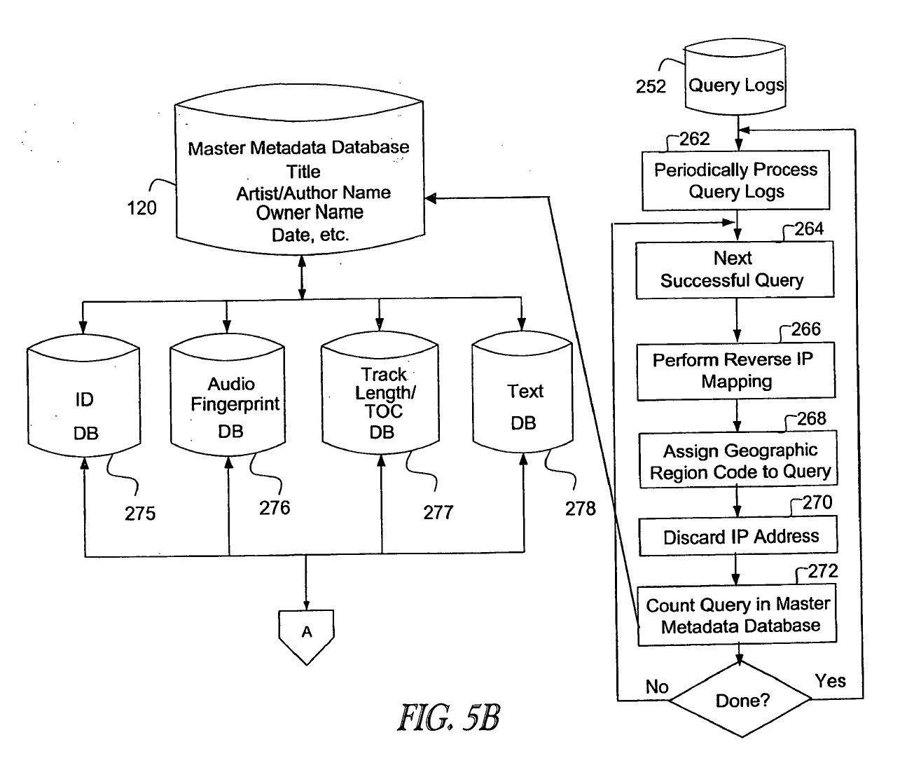

As illustrated in FIG. 5A, when an unidentified recording 232 (compact disc or digital music file) is played by client device 140, information 234-237 is sent to server(s) 146. Server(s) 146 perform matching operations 241-244 on information 234-237, respectively and return results 246, if any, to client device 140. In the preferred embodiment, this is done via a request transmitted via a network, such as the Internet using a protocol, such as the Internet Protocol (IP). When IP is used, each request is logged into off-line query logs 250 for periodic processing. Part of the information logged is an identifier of the item requested (if successfully identified) and the IP address of the requester.

Periodically, the query logs 250 are processed 262 as illustrated in FIG. 5B to record the identifier of all successfully recognized pieces of music. For each successful query 264, the IP address is translated 266 into a geographic location. This is performed using a technique known as “reverse IP” mapping 266, that takes an IP address and looks up the probable geographic location in a “reverse IP” database, such as that available in the NetAccuity product from Digital Envoy of Atlanta, Ga. Since the geographic region code assigned 268 to a query typically has no finer granularity than country and metropolitan region or city, once the IP address is discarded 270, the query may be counted 272 in master metadata database 120 anonymously. The geographic location can then be used in combination with data in other databases 275-278 as discussed below.

Preferably, a genre compatibility matrix is maintained to improve the quality of playlists generated using the system according to the present invention. For example, it is important to know that Christian Rock and Heavy Metal are less compatible than Heavy Metal and Death Metal. Compatibilities are not symmetrical; therefore, it is also necessary to provide information about incompatibility. Preferably, information is stored regarding both, rather than trying to infer one from the other. In an embodiment of the present invention, a genre compatibility matrix consists of N×N cells created by rating the compatibility between each of N genres. This requires comparing N*(N−1)/2 genres. For example, ten genres require 45 comparisons between genres. Compatibility information may be generated by human editors or data mining.

While it is feasible for human editors to generate the genre compatibility matrix provided N is in the low hundreds, it is impractical for human editors to generate an artist compatibility matrix, since there are tens of thousands of artists and many hundreds of new ones each month.

The preferred method for generating both the genre compatibility matrix and an artist compatibility matrix is to use data mining. Collaborative filtering techniques are applied to the information obtained when recordings are played by users to relate one set of artists, albums or songs to other artists, albums or songs. From this data, a worldwide set of relationships between artists can be established that provide additional intrinsic subjective attributes such as “similar artists” for those in related genres, “affinity artists” for those artist relationships where though not similar in genres are, none-the-less, often found to be listened to by the same users. It is also possible to generate dissimilar artist” and non-affinity artist-relationships. An example of a genre compatibility table is provided below.

As shown in the partial table below, for each General genre there is a set of associated other subgenres. For example, the Country General genre contains the subgenres numbered 56, 57, 59, 58, 60, 61, and 62 referred to as a genre correlates. For each of these subgenres, a set of related subgenres are specified such as that shown for Alternative Country where the related subgenres are 57, 61, 62, 8, 29, 95, and 209. In this case 57 is the Bluegrass subgenre and related to Country by a weight of 5 (on a scale of 1-10). Alternative Country does not have a genre correlate with Country Blues (58) or Traditional Country (59) in this example. However Bluegrass, has a relationship to Alternative Country with a weight of 7, and to Traditional Country (59) with a weight of 8. Using the set of genre correlates and the explicit weighting for each correlate allows song similarity to be derived by comparing the genres of two songs, which is used in creating a playlist of similar songs.

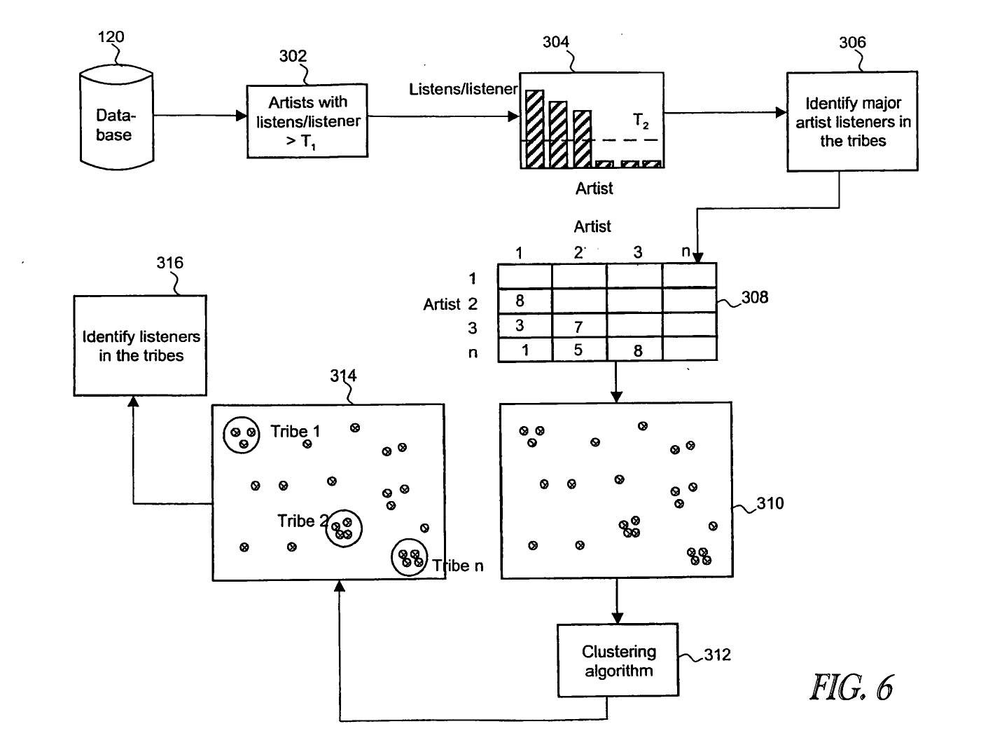

The following table is a subset of a complete compatibility matrix for the genres included in this table. Only those genre-pairs with a compatibility value greater than some predetermined value are shown. Compatibilities are shown as values between 1 and 10, with a higher number indicating a greater compatibility, as described below with respect to FIG. 6.

| | Meta- | Sub- | | | | | | | | |
|---|---|---|---|---|---|---|---|---|---|---|
| ID | Genre | Genre | Related genres over weight assigned thereto | | | | | | | |
| 40 | Clas- | Classical | 40 | 41 | 42 | 43 | 47 | 44 | 45 | 46 |
| | sical | | | | | | | | | |
| 41 | | Baroque | 42 | 43 | 45 | 46 | 50 | 51 | 53 | 54 |
| | | | 9 | 6 | 7 | 4 | 3 | 8 | 7 | 5 |
| 42 | | Chamber | 41 | 45 | 46 | 50 | 51 | 53 | 54 | 261 |
| | | Music | | | | | | | | |
| | | | 9 | 5 | 4 | 6 | 8 | 3 | 7 | 4 |
| 43 | | Choral | 44 | 45 | 46 | 48 | 49 | 50 | 53 | 179 |
| | | | 6 | 5 | 4 | 8 | 9 | 7 | 5 | 7 |
| 44 | | Contem- | 43 | 45 | 46 | 51 | 54 | 261 | 91 | 167 |
| | | porary | | | | | | | | |
| | | | 5 | 5 | 4 | 7 | 8 | 4 | 8 | 6 |
| 45 | | Ensembles | 41 | 43 | 46 | 48 | 50 | 51 | 53 | 54 |
| | | | 6 | 5 | 4 | 5 | 7 | 6 | 4 | 8 |
| 46 | | General | 41 | 42 | 43 | 44 | 45 | 47 | 48 | 49 |
| | | Classical | | | | | | | | |
| | | | 7 | 4 | 5 | 7 | 4 | 5 | 4 | 8 |
| 49 | | Opera | 41 | 43 | 44 | 46 | 50 | 261 | 69 | |
| | | | 6 | 8 | 7 | 4 | 9 | 4 | 5 | |
| 50 | | Romantic | 42 | 43 | 44 | 45 | 46 | 49 | 51 | 54 |
| | | Era | | | | | | | | |
| | | | 6 | 5 | 7 | 6 | 4 | 8 | 8 | 6 |
| 53 | | Renais- | 41 | 42 | 43 | 45 | 46 | 48 | 54 | 261 |
| | | sance | | | | | | | | |
| | | Era | | | | | | | | |
| | | | 7 | 5 | 8 | 5 | 4 | 9 | 6 | 4 |
| 54 | | Strings | 41 | 42 | 44 | 45 | 46 | 47 | 50 | 53 |
| | | | 6 | 7 | 5 | 8 | 4 | 8 | 7 | 5 |
| 55 | Country | Country | 56 | 57 | 58 | 59 | 60 | 61 | 62 | |
| 56 | | Alterntv. | 57 | 61 | 62 | 8 | 29 | 95 | 209 | |
| | | Country | | | | | | | | |
| | | | 5 | 4 | 3 | 9 | 7 | 8 | 6 | |
| 57 | | Blue- | 56 | 59 | 8 | 29 | 228 | 236 | 37 | |
| | | grass | | | | | | | | |
| | | | 7 | 8 | 2 | 6 | 4 | 3 | 5 | |
| 58 | | Country | 56 | 57 | 59 | 60 | 29 | 30 | | |
| | | Blues | | | | | | | | |
| | | | 5 | 7 | 9 | 8 | 6 | 4 | | |
| 59 | | Tradl. | 57 | 58 | 60 | 61 | 62 | 63 | 95 | 209 |
| | | Country | | | | | | | | |
| | | | 7 | 6 | 9 | 5 | 8 | 3 | 4 | 5 |

An embodiment of the present invention also identifies “music tribes” which are groups of listeners who predominately listen to a few artists with great regularity. Examples are fans of the Grateful Dead or Jimmy Buffett. Observations of human behavior have revealed that people like to identify themselves with groups of like-minded people (in tribes), whether they are compatriots, political parties, or music fans. The present invention preferably identifies music tribes for the purpose of providing a sense of community to these like-minded people and to be able to create playlists that are more appealing to one tribe than another.

A method for identifying tribes is illustrated in FIG. 6. Data 302 from master metadata database 120 are selected for artists with listens per listener greater than a predetermined or heuristically determined threshold T₁. The selected data include music use identified by artist, title and (anonymized) user and may include language and locale of the artist, language and locale of the user, etc. These artists are grouped 304 into major artists and minor artists based on a threshold T₂ of listens per listener. Listeners to each of the major artists are identified 306 as belonging to that artist's tribe. A compatibility matrix is created 308 for minor artists with listens per listener below threshold T₂. Only minor artists are used, because major artists are likely to have compatibility with a large number of artists causing the data to be skewed. The artist compatibility matrix is an N×N matrix where N is the number of unique artists and the value in each cell of the matrix represents the compatibility between different artists. A sample matrix is illustrated in block 308 of FIG. 6 where artists who are not listened to together are assigned a value 1. Thus, high values such as 8 and 7 indicate that the artists, e.g., 1 and 2, and 2 and 3, are often listened to by the same users.

The compatibility matrix may be represented using a two-dimensional graph 310 of distances between artists. Distance is the inverse of compatibility, such that a distance number is equivalent to a high compatibility number. Artists that are compatible will appear at clusters of closely spaced points in the two-dimensional space. A cluster identification algorithm 312 is executed to identify compatible artists who are then assigned 314 tribe identifications. It is then possible to identify 316 listeners represented by the tribes 314. In addition, language and locale of the artist or users may be used to further refine the music tribes 314.

Music tribes represent groups of users for whom certain inferences may be made about their psychographics. Psychographics uses psychological, sociological and anthropological factors to determine how a market is segmented by the propensity of groups within the market to make a decision about a product, person, ideology or otherwise hold an attitude or use a medium. This information can be used to better focus commercial messages and opportunities. For example, opportunities to purchase new music or merchandise from the artist. The information can also be used to focus the creation of playlists. For example, playlists for the members of a tribe might contain more music from the artist(s) defining the tribe.

Once the users of the system who belong to a music tribe have been identified, it is possible to identify “elders” within the tribe. These “elders” are individuals who are the most avid listeners to the artists defining the tribe. It may be inferred that these individuals have more expertise about the defining artists. Therefore, the behavior of these users is given a different weight in assessing the likely popularity of new artists amongst the other members of the tribe. This requires identifying the defining artists listened to by the tribe, as described above and illustrated in FIG. 6. It is possible to calculate the incidents of number of listens to defining and non-defining artists, normalize the number of listens to probability and calculate each member's probability of listening to defining versus non-defining artists. A delta probability threshold is established by examining the shape of the probability function and used to identify as elders those members of the tribes whose delta probability of listening to a defining versus nondefining artist is above the threshold.

In addition to identifying elders, an embodiment of the present invention may identify “trend setters” who have consistently listened to artists and/or tracks that later became popular before the general listening public began listening to those artists and/or tracks. This is one type of leading indicator that can predict the popularity of an artist, album or track based on listens, number of listeners, duration of listens, locale of listens, time at which the listens occurred, and derivatives of these measures for artists, tracks and albums. The listening behavior of trend setters is a leading indicator of an artist's or track's popularity. Tracks and artists that are predicted to be popular can be added to playlists for people who wish to listen to popular music and to other trend setters.

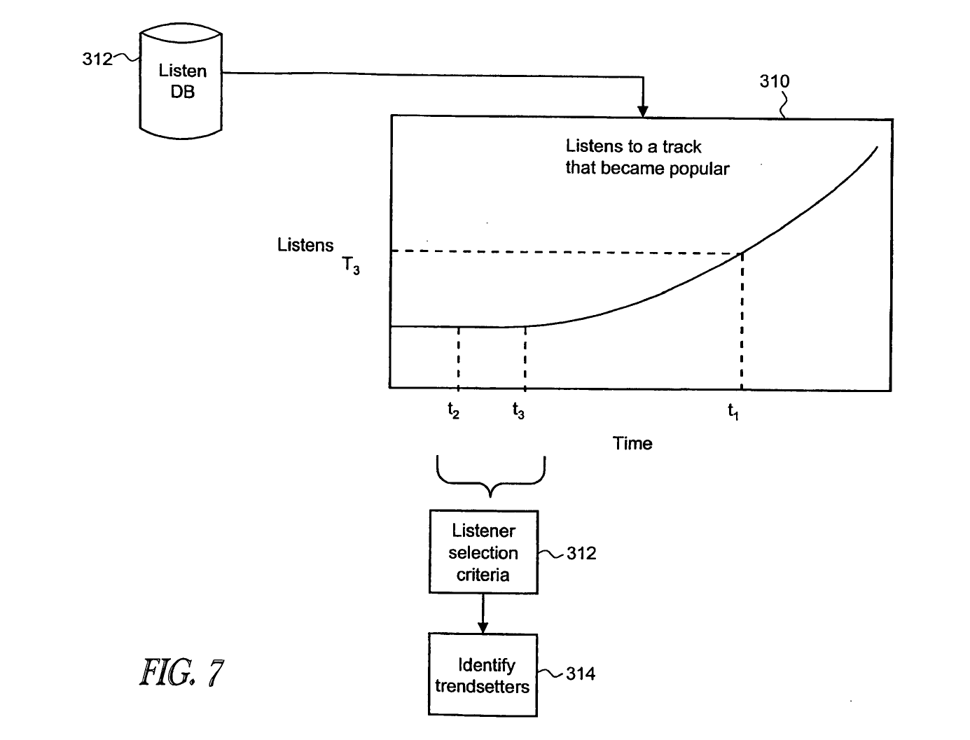

A method for identifying trend setters is illustrated in FIG. 7. A graph 310 representing listens versus time shows how a threshold T₃ can be selected as defining popularity. Using a database 312 of accesses to master metadata database 120 (e.g., by sampling number of listens in master metadata database 120 over time), the time t₁ at which threshold T₃ is reached can be determined. A range of time t₂ to t₃ is selected prior to the time that the track became popular. This period of time is referred to as the “prediction window.” Listeners of the song during the prediction window are identified and subjected to listener selection criteria 312 to identify 314 trendsetters. Listener selection criteria 312 may include minimum number of listens per unit time, minimum number of people to be designated as trendsetters and maximum number of people to be designated as trendsetters. This process may be repeated for different tracks to identify listeners who are consistent trendsetters across many tracks. Using observed music affinity information, i.e., what music the trendsetters prefer, along with artists or genre compatibility information, the most appropriate trendsetters can be selected to increase the accuracy of popularity prediction for a particular track of interest.

A “rising star” is an artist who is likely to become popular in the future. Identifying a rising star uses the assumption that a new star must recruit listeners from existing artists. A rising star may be identified by applying selection criteria using information determined as discussed above. One type of information is the recruitment of listeners from existing tribes. In addition, the number of listens by trendsetters, the number of listens overall, the number of different listeners and the locale of the listeners can all be used to aid and identifying a rising star.

An embodiment of the present invention also gathers popularity data for all albums (CDs and recordings (songs). This popularity data can be assigned world popularity, regional popularity, national popularity, genre popularity and relative popularity for individual songs in relation to other songs on an album on which it originally, or most popularly, appears.

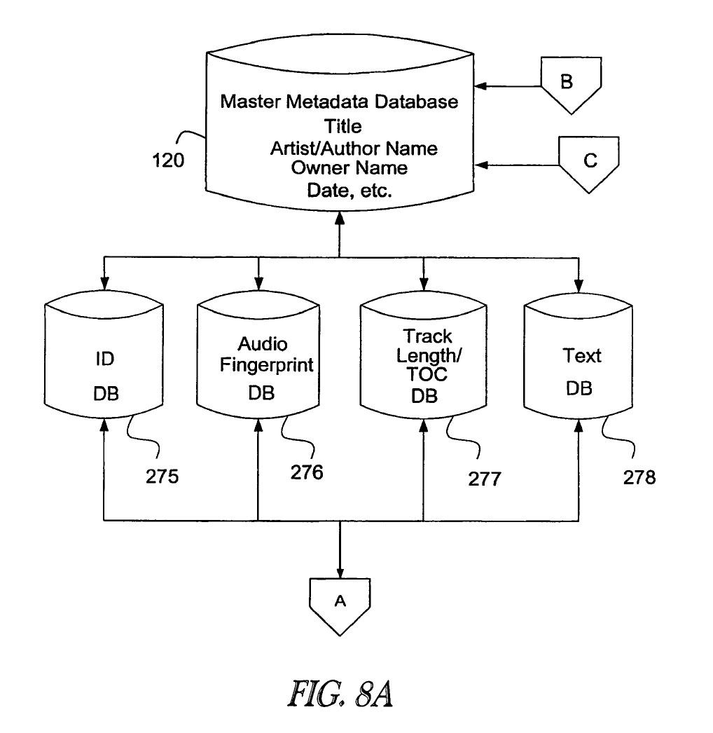

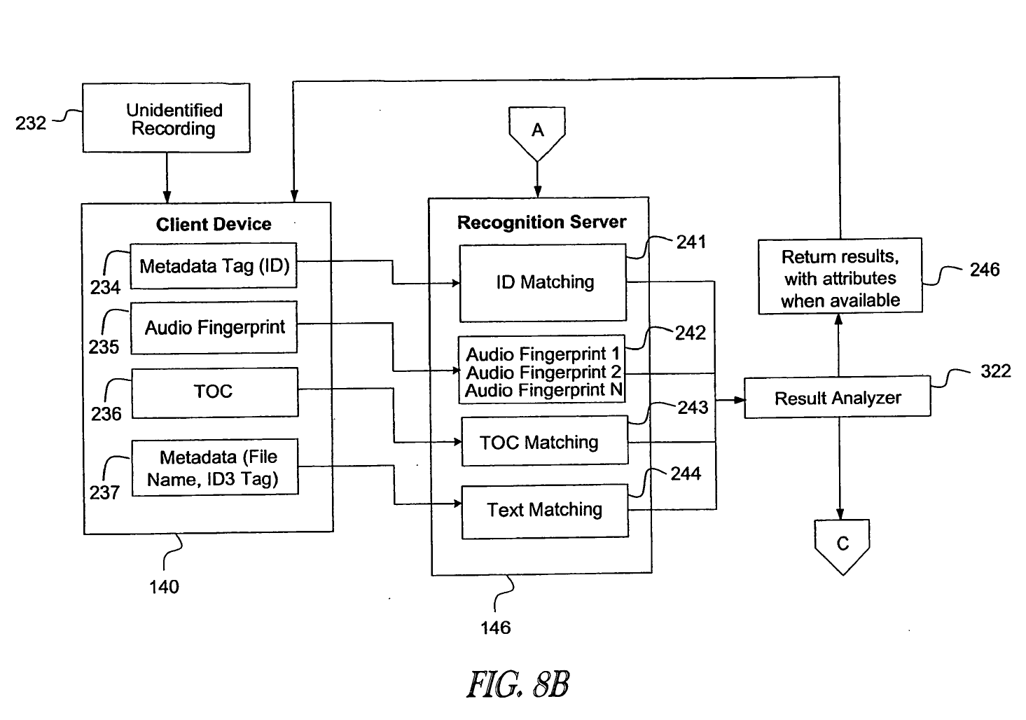

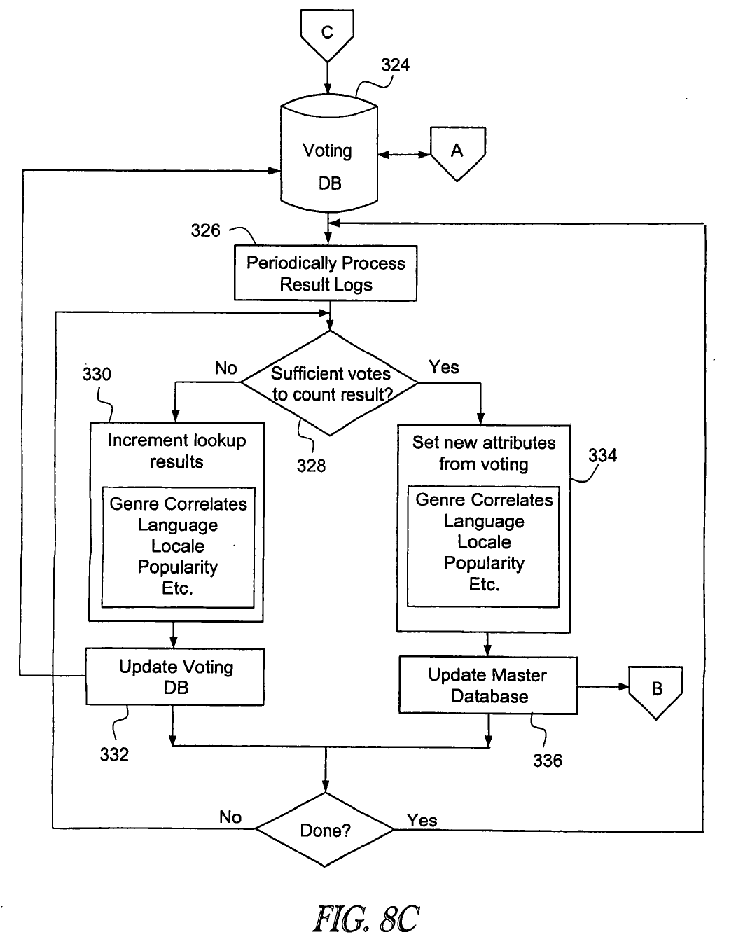

With the information and attributes created using the methods described above, it is possible to automatically collect attributes stored in master metadata database 120 and one or more of the results matching databases 275, 276, 277, and 278 illustrated in FIG. 8A.

An overview of the process is illustrated in FIG. 8C where voting database 324 is used to maintain the current number of users for which results have been successfully identified for the albums and songs in the master metadata database 120. Periodically, these results are reviewed 326 algorithmically to determine if there are a sufficient number of users that have requested music identification to count their aggregate results. Sufficiency can be determined as a predetermined value or driven by the overall popularity of the identified music. More popular music would require more users to “vote” before counting those results. When it is determined 326 that insufficient votes are in voting database 324, the results associated with the successful identification are incremented 330, including genre correlates, language, locale, popularity, etc., and the incremented results are then used to update 332 voting database 324 If sufficient votes are contained in voting database 324 to count the results, new attributes are generated 334 from voting, including genre correlates, language, locale, popularity, etc., to update 336 master metadata database 120 and the associated matching databases 275, 276, 277, and 278.

These intrinsic and extrinsic attributes are then made available to requesting client applications in addition to the basic metadata provided by the music information service, specifically to facilitate the generation of playlists.

In addition to these results, other information may also be returned to the client such as a genre correlation table if a version is available that has been more recently revised than the one currently held by the client.

The music identification system described above is typically utilized by an application responsible for managing music collections. Such applications must be knowledgeable of all music available to be managed, typically stored locally, though externally stored collections (on external storage media or on-line in music subscription services) are an alternative embodiment.

The typical music management application will ensure all music recordings of which it is cognizant are properly tagged and ready to be incorporated into one or more playlists for the user. The music is typically managed by utilizing the basic metadata of the music in its collection, providing sorting and grouping by artist name, album name, and genre.

In this invention, the music management application will also provide sorting and grouping by the intrinsic and extrinsic attributes to create collections and playlists for the user. All songs that have a genre sufficiently similar to the song or genre selected by the user are candidates for the playlist. The number of candidates can be reduced for a particular playlist by filtering using additional attributes. For example, track popularity, locale of artist and listener, artist compatibility, tempo, and others. The genre relationship table, and other additional information can reside on the client device or on the music information server.

Another feature of the music management application is to synchronize music collections and playlists with external portable devices. Songs and playlists are loaded onto the portable devices using a synchronization mode, ensuring the external device has up-to-date information for all the songs and music stored locally on the device.

The preferred embodiment of this invention creates a separate file, or files, on the portable device, that contain(s) extended metadata for each song along with the intrinsic and extrinsic attributes associated with each song. These attributes are augmented by local playback information gathered from monitoring user playback behavior locally in the music management application and on the external portable device. This local playback information is consolidated by the music management application.

The music management application can use the basic metadata, plus all the “enhanced music management data” such as extended metadata, consolidated playback information, and intrinsic/extrinsic attributes for each song, to create playlists and/or sets of music files to load onto the external portable device.

Playlists loaded onto the external portable device can be played directly by the portable device. However, the availability of the additional information provided, “enhanced music management data”, also allows the portable device to also provide advanced playlist creation capabilities.

### Interface for Playlist Manipulation

Most portable music playing devices have several common sets of functionality:
Ability to play music using commonly used CD player functions (play, stop, pause, skip back, skip ahead)
Limited user interactive functions
Limited storage capacity (5 GB, 10 GB, etc.)
Limited display capability (1-2 lines of 16-32 characters each)

Most portable music playing devices have been creative at providing maximum functionality given these sets of constraints. An embodiment is described below for insuring simply user interaction is available that allows complete playlist creation, editing and playback utilizing the standard set of CD player functions with access to enhanced music management data described above. This enables playlist management by even the most rudimentary digital audio player using three manageable pieces:
A simple user interface for playlist management suitable for implementation on devices with limited display and input capabilities
Simplified playlist creation using genres and a hierarchical genre relationship mapping available for basic metadata CD and song information.
Advanced playlist creation using related artists, album and songs derived from local and aggregated listening behavior information.

Most consumer electronics devices for audio playback of compact disks or digital audio files use the 5 buttons of play, stop, pause, back and forward, often using icons to represent the functions of a rightward pointing triangle, square, parallel vertical lines and the combination of a vertical line and a triangle pointing backwards or forwards, respectively. To avoid the additional cost and increase to confusion of additional buttons for playlist management, this embodiment uses these conventional buttons for playlist management in combination with a display preferably capable of displaying at least 16 characters.

In an embodiment of the present invention, the playlist mode is entered by holding the play or pause button for 2 or 3 seconds. This causes a re-mapping of the buttons as follows:

PLAY—Select

STOP—Done

PAUSE—Playlist

BACK—Previous

FORWARD—Next

This mapping of operations with buttons is used throughout with secondary functions specifically named to form a consistent set of commands to control the playlist management system.

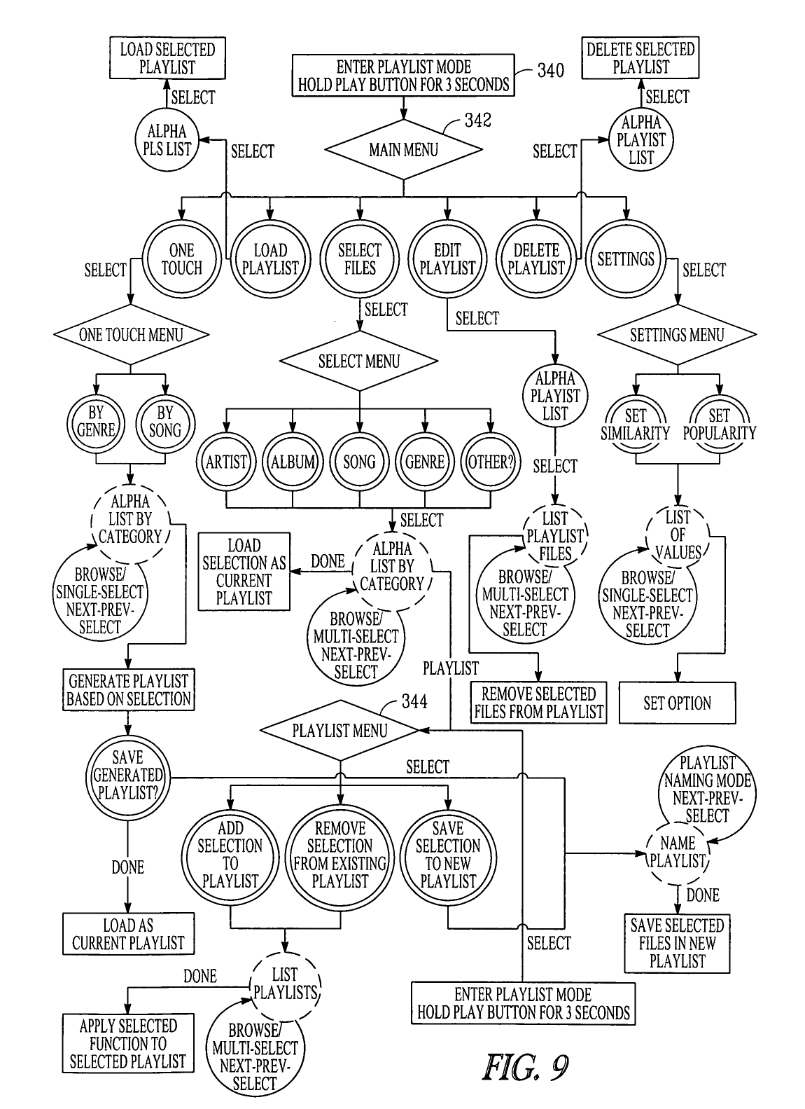

As illustrated in FIG. 9, there are two ways to enter the state diagram representing the playlist user interface for limited display devices. By holding 340 the PLAY button for about 2-3 seconds main menu 342 is entered. Alternatively, playlist menu 344 may be entered by holding 346 the pause button for about 2-3 seconds. Within the playlist mode state diagram, there are 4 basic states in which the standard Next, Previous, Select and Done buttons have slightly different uses within each of these 4 basic states.

In the menu states 342, 344, the user navigates between choices that determine what functions are to be performed. The choices are illustrated as double dashed ringed circles. Next and Previous move between choices, Select chooses the current item and Done exits the current menu and returns to the previous menu or exits the playlist mode if no previous menu exists. In one of the single selection states indicated by single dashed line circles, a user selects one choice among a list of candidates. Next and Previous move between candidates and Select chooses the current candidate.

In the multiple-selection states, indicated by heavy broken circles, a user may select multiple candidates in a list of candidates. As in the case of the single selection state, Next and Previous move between candidates, but Select toggles the selection or de-selection of a candidate and Done completes the selection process. In the naming states, indicating by narrow dotted circles, users create an alpha numeric string using Next and Previous to navigate characters, Select to set the current character and Done to complete the string.

The simplest function of the system is to create a playlist using a minimal number of button presses, referred to as “One Touch” playlist generation since only a single genre or song is required to be selected to produce a playlist from the user's music collection of similar songs (based upon similarity and popularity information supplied by the systems described above). To do this, the user holds down the PLAY button for 3 (or more seconds) to enter the Main Menu state. At this point the Main Menu sequentially displays “One Touch”, “Load Playlist”, “Select Files”, “Edit Playlist”, “Delete Playlist”, and “Settings” with each press of the FORWARD/Next button. The default could be any of these options, but in the preferred embodiment the One Touch option is the default. To select the “One Touch” option, the user presses the PLAY/Select button again, which takes user to the One Touch Menu.

At this point the One Touch Menu sequentially displays “by genre” and “by song” (looping back to “by genre”, “by song” as necessary) with each press of the FORWARD/Next button. To select the “by genre” option, the user presses the PLAY/Select button again, which takes the user to a state where a sequential set of genres are displayed (e.g., “classical”, “rock”, “folk”, etc.) with each press of the FORWARD/Next button. The preferred embodiment of this invention presents the order of genres as alphabetical by default, and then by order of most frequent genre selections as the system is used. A genre is selected by pressing the PLAY/Select button again, which then generates a playlist from all of the user's current music files that meet the genre similarity and popularity criteria settings. The preferred embodiment of this invention presets generally useful values for the similarity and popularity settings, but these values may be adjusted by the user using the Settings option. After a One Touch playlist has been generated, the system then queries the user to “save generated playlist”, after which the One Touch function is done and the current playlist played via the standard CD function buttons, which return to their original functions (i.e., PLAY, STOP, PAUSE, BACK, FORWARD).

Similarly, to load a previously saved playlist the user holds the PLAY/Select button for 3 (or more) seconds to enter the Main Menu state. At this point the Main Menu sequentially presents “One Touch”, “Load Playlist”, “Select Files”, “Edit Playlist”, “Delete Playlist”, and “Settings” with each press of the FORWARD/Next button. The default could be any of these options, but in the preferred embodiment the One Touch option is the default. To select the “Load Playlist” option, the user presses the FORWARD/Next button, at which point the “Load Playlist” option is displayed and presses the PLAY/Select button, which takes the user to the Load Playlist state.

At this point the system presents an alphanumerically sorted list of previously generated playlists. The preferred embodiment of this invention presents the order of playlists as alphabetical by default, and then by order of most frequently selected playlists as the system is used. The system sequentially displays the name of each playlist with each press of the FORWARD/Next button. To select a playlist, the user presses the PLAY/Select button again, after which the Load Playlist function is done and the selected playlist played via the standard CD function buttons, which now return to their original functions (i.e., PLAY, STOP, PAUSE, BACK, FORWARD).

Similarly, to select files for inclusion in a playlist the user holds down the PLAY button for 3 (or more) seconds to enter the Main Menu state. At this point the Main Menu sequentially displays “One Touch”, “Load Playlist”, “Select Files”, “Edit Playlist”, “Delete Playlist”, and “Settings” with each press of the FORWARD/Next button. To select the “Select Files” option, the user presses the FORWARD/Next button twice, at which point the “Select Files” option is displayed and presses the PLAY/Select button, which takes the user to the Select Files state.

At this point the Select Menu sequentially displays “artist”, “album”, “song”, “genre”, and “other” with each press of the FORWARD/Next button. To select by “artist” option, the user presses the PLAY/Select button again, which takes the user to a state where a sequential set of artist names are displayed alphabetically (e.g., “Bob Dylan”, “Bob Seger”, etc.) with each press of the FORWARD/Next button. The artist names obtained from the metadata associated with each song in the users music collection. An artist is selected by pressing the PLAY/Select button again, which then generates a playlist from all of the user's current music files of all the songs by that artist. Optionally, popularity criteria setting could also be used if selected previously by the user for artist playlists. After the songs by the selected artist have been added to the current playlist, the user can indicate his selections are complete by pressing the STOP/Done button or continue to select other artists by pressing the BACK/Previous button to return to the artist selection state. When all artist selections are done the user indicates by holding down the STOP/Done button for 3 (or more) seconds to load the current playlist so that it can be played via the standard CD function buttons, which return to their original functions (i.e., PLAY, STOP, PAUSE, BACK, FORWARD).

Similarly, the “album”, “song”, “genre”, and “other” options may be accessed in the Select Menu to create a playlist, as detailed in FIG. 9.

The other functions of the Main Menu state as detailed in FIG. 9 (“Edit Playlist”, “Delete Playlist”, “Settings”) work in a similar fashion to that of the “One Touch”, “Load Playlist”, and “Select Files” states described above.

To enter the Playlist Menu state the user holds down the PAUSE button for 3 (or more) seconds. At this point the Playlist Menu state sequentially displays “add selection to playlist”, “remove selection from playlist”, and “save selection to new playlist” with each press of the FORWARD/Next button. The default could be any of these options, but in the preferred embodiment the “add selection to playlist” option is the default. To select the “add selection to playlist” option, the user presses the PLAY/Select button again, which takes the user to the “add selection to playlist” state.

At this point a sequential set of previously generated playlist names are displayed alphabetically (e.g., “jazz favorites”, “Latin songs”, “rock hits”) with each press of the FORWARD/Next button. The user views the list of playlists and selects one to add selection to by pressing the PLAY/Select button. Once a playlist has been selected, a list of song names from the user's music collection is displayed alphabetically (e.g., “Against The Wind”, “Nine Tonight”, etc.) with each press of the FORWARD/Next button. A song is selected by pressing the PLAY/Select button again, which then adds the selected song to the previously selected playlist. The songs in the users music collection are displayed one at a time until the users indicates he is finished by holding down the STOP/Done button for 3 (or more) seconds. At this point the selected playlist, with its new additions, is played via the standard CD function buttons, which return to their original functions (i.e., PLAY, STOP, PAUSE, BACK, FORWARD).

Similarly, to remove files from an existing playlist the user holds down the PAUSE button for 3 (or more) seconds. At this point the Playlist Menu state sequentially displays “add selection to playlist”, “remove selection from playlist”, and “save selection to new playlist” with each press of the FORWARD/Next button. To select the “remove selection from playlist” option, the user presses the PLAY/Select button twice, which takes the user to the “add selection to playlist” state.

At this point a sequential set of previously generated playlist names are displayed alphabetically (e.g., “jazz favorites”, “Latin songs”, “rock hits”) with each press of the FORWARD/Next button. The user views the list of playlists and selects one to remove a selection from by pressing the PLAY/Select button. Once a playlist has been selected, a list of song names from the selected playlist is displayed alphabetically (e.g., “Against The Wind”, “Nine Tonight”, etc.) with each press of the FORWARD/Next button. A song is selected for removal by pressing the PLAY/Select button again, which then removes the selected song from the previously selected playlist. The songs in the selected playlist are displayed one at a time until the users indicates he is finished by holding down the STOP/Done button for 3 (or more) seconds. At this point the selected playlist, with its pared down set of songs, is played via the standard CD function buttons, which return to their original functions (i.e., PLAY, STOP, PAUSE, BACK, FORWARD).

Similarly, to save the current playlist to a new named playlist the user holds down the PAUSE button for 3 (or more) seconds. At this point the Playlist Menu state sequentially displays “add selection to playlist”, “remove selection from playlist”, and “save selection to new playlist” with each press of the FORWARD/Next button. To select the “save selection to new playlist” option, the user presses the PLAY/Select button three times, which takes the user to the “save selection to new playlist” state.

At this point the user is expected to enter a name for the new playlist. Since there is no standard keyboard available with all of the alphanumeric keys for entering an arbitrary name for the playlist, a method of entering alphanumeric characters is implemented using the FORWARD/Next and BACK/Previous buttons to navigate through the alphabet, numeric, and special symbol characters, along with the PLAY/Select button to indicate which characters to select. The user views the characters as they are displayed alphabetically (e.g., “A”, “B”, etc.) with each press of the FORWARD/Next button. A character is selected for inclusion by pressing the PLAY/Select button, which adds the character to the currently being constructed character string displayed for reference in the limited character display panel. The last character is deleted from the current string by pressing the BACK/Previous button. Characters are added one at a time to the character string until the user indicates he is finished by holding down the STOP/Done button for 3 (or more) seconds. At this point the current playlist is saved to a named playlist that may be recalled at a later time using the “Load Playlist” function of the Main Menu. The standard CD function buttons are then returned to their original functions (i.e., PLAY, STOP, PAUSE, BACK, FORWARD).

Using the navigation and selection process of this embodiment, playlists can be created and edited, music files selected and sorted by various criteria while working with a large number of files, and requiring only a minimal display of a single line of text.

The many features and advantages of the invention are apparent from the detailed specification and thus, it is intended by the appended claims to cover all such features and advantages of the invention that fall within the true spirit and scope of the invention. Further, since numerous modifications and changes will readily occur to those skilled in the art, it is not desired to limit the invention to the exact construction and operation illustrated and described and accordingly, all suitable modifications and equivalents may be resorted to, falling within the scope of the invention.

What is claimed is:

1. A method comprising:
collecting information on playback of recordings containing audio in a plurality of geographic regions;
segregating the information and corresponding metadata by the geographic regions; and
selecting a portion of the corresponding metadata for one of the geographic regions based on the information.

2. The method of claim 1, further comprising:
storing the portion of the corresponding metadata in a computer-readable memory.

3. The method of claim 1, wherein the collecting, the segregating and the selecting are performed automatically by a programmed computer system.

4. The method of claim 1, wherein the selecting comprises:
selecting the portion of the corresponding metadata for popular recordings that the information indicates are popular within at least one of the geographic regions.

5. The method of claim 1, wherein the selecting is repeated for more than one of the geographic regions.

6. A method comprising:
obtaining first metadata associated with a first recording;
accessing corresponding metadata for a geographical region obtained by collecting information on playback of a plurality of recordings in a plurality of geographic regions;
segregating the information and the corresponding metadata by the geographic regions;
selecting a portion of the corresponding metadata for at least one of the geographic regions based on the information, to provide a selected portion of the corresponding metadata; and
matching the first metadata with second metadata in the selected portion of the corresponding metadata.

7. The method of claim 6, wherein the obtaining comprises:
reading at least one of a filename or an ID3 tag of the recording.

8. The method of claim 6, wherein the selected portion of the corresponding metadata comprises:
at least one of artist names, album names, song names, genre and sub-genre information, release data, or country of origin.

9. The method of claim 6, comprising:
accessing the corresponding metadata for a selected set of recordings; and
selecting related recordings from the selected set of recordings to form a playlist, wherein the related recordings have matching values for at least one type of the corresponding metadata.

10. The method of claim 9, wherein the corresponding metadata comprises:
at least one of artist names, album names, song names, genre and sub-genre information, release data, or country of origin.

11. An apparatus comprising:
a memory including instructions which, when executed by a processor, operate to store selected metadata for a geographical region obtained by collecting information on playback of recordings containing audio in a plurality of geographic regions, segregating the information and corresponding metadata by the geographic regions, and selecting a portion of the corresponding metadata to provide the selected metadata for the geographic region based on the information; and
re-mappable buttons to be re-mapped according to the instructions and a mode of operation of the apparatus.

12. The apparatus of claim 11, wherein the instructions, when executed by the processor, operate to obtain first metadata associated with a selected recording, to access the selected metadata, and to match the first metadata with second metadata in the selected metadata.

13. The apparatus of claim 11, further comprising:
a display, wherein the instructions, when executed by the processor, operate to access first and second metadata for a set of the recordings and to select related recordings from the set of recordings to form a playlist to be displayed on the display, wherein the related recordings have matching values for at least one type of the corresponding metadata.

14. A computer readable medium to store instructions which, when executed by a processor, cause the processor to perform a method comprising:
collecting information on playback of recordings containing audio in a plurality of geographic regions;
segregating the information and corresponding metadata by the geographic regions; and
selecting a portion of the corresponding metadata for one of the geographic regions based on the information.

15. The computer readable medium of claim 14, wherein the method further comprises:
grouping the recordings by one of intrinsic or extrinsic attributes.

16. The computer readable medium of claim 14, wherein the method further comprises:
grouping the recordings by music tribe identification.

17. The computer readable medium of claim 14, wherein the selecting comprises:
selecting the portion of the corresponding metadata for popular recordings that the information indicates are popular within at least one of the geographic regions.

18. The computer readable medium of claim 14, wherein the method further comprises:
maintaining a genre relationship table.

19. A computer readable medium to store instructions which, when executed by a processor, cause the processor to perform a method comprising:
obtaining first metadata associated with a first recording;
accessing corresponding metadata for a geographical region obtained by collecting information on playback of a plurality of recordings in a plurality of geographic regions;
segregating the information and the corresponding metadata by the geographic regions;
selecting a portion of the corresponding metadata for at least one of the geographic regions based on the information, to provide a selected portion of the corresponding metadata; and
matching the first metadata with second metadata in the selected portion of the corresponding metadata.

20. The computer readable medium of claim 19, wherein the obtaining comprises:
reading at least one of a filename or an ID3 tag of the recording.

21. The computer readable medium of claim 19, wherein the selected portion of the corresponding metadata include at least one of artist names, album names, song names, genre and sub-genre information, release data, or country of origin.

22. The computer readable medium of claim 19, wherein the method further comprises:
accessing the corresponding metadata for a set of recordings containing audio; and
selecting related recordings from the set of recordings to form a playlist, wherein the related recordings have matching values for at least one type of the corresponding metadata.

23. The computer readable medium of claim 22, wherein the corresponding metadata include at least one of artist names, album names, song names, genre and sub-genre information, release data, or country of origin.
